(19) United States
(12) Patent Application Publication
(10) Pub. No.: US 2023/0281458 A1
(43) Pub. Date: Sep. 7, 2023

(54) METHOD AND SYSTEM FOR REDUCING COMPLEXITY OF A PROCESSING PIPELINE USING FEATURE-AUGMENTED TRAINING

(71) Applicant: Samsung Electronics Co., Ltd., Suwon-si (KR)

(72) Inventors: Aviral AGRAWAL, Ghaziabad (IN); Raj Narayana GADDE, Bangalore (IN); Anubhav SINGH, Bangalore (IN); Yinji PIAO, Suwon-si (KR); Minwoo PARK, Suwon-si (KR); Kwangpyo CHOI, Suwon-si (KR)

(21) Appl. No.: 18/174,976

(22) Filed: Feb. 27, 2023

Related U.S. Application Data
(63) Continuation of application No. PCT/KR2023/002575, filed on Feb. 23, 2023.

(30) Foreign Application Priority Data
Mar. 3, 2022 (IN) 202241011605
Feb. 2, 2023 (IN) 2022 41011605

(51) Int. Cl. G06N 3/091; G06T 9/00

(52) U.S. Cl. CPC G06N 3/091; G06T 9/002

(57) ABSTRACT

A method and an electronic device for low-complexity in-loop filter inference using feature-augmented training are provided. The method includes combining spatial and spectral domain features, using spectral domain features for global feature extraction and signalling to the spatial stream during training, using a detachable spectral domain stream for differential complexity during training versus inference, and combining a unique set of losses resulting from multi-stream and multi-feature approaches to obtain an optimal output.

### CROSS-REFERENCE TO RELATED APPLICATION(S)

This application is a continuation application, claiming priority under § 365(c), of an International application No. PCT/KR2023/002575, filed on Feb. 23, 2023, which is based on and claims the benefit of an Indian Provisional patent application number 202241011605, filed on Mar. 3, 2022, in the Indian Intellectual Property Office, and of an Indian Complete patent application number 202241011605, filed on Feb. 2, 2023, in the Indian Intellectual Property Office, the disclosure of each of which is incorporated by reference herein in its entirety.

### TECHNICAL FIELD

The disclosure relates to an artificial intelligence (AI). More particularly, the disclosure relates to a method and a system for reducing complexity of a processing pipeline using feature-augmented training.

### BACKGROUND ART

In general, video compression is a process of reducing the amount of data required to represent a specific image or video clip/content. For the video content, this reduction in the amount of data means fewer storage requirements and lower transmission bandwidth requirements. Video compression typically entails the removal of information that is not required for viewing the video content. There are a number of existing methods for video compression in existing compression systems including intra-frame compression (or spatial), such as motion joint photographic experts group (JPEG) (M-JPEG), inter-frame compression, such as H.264. However, the video content that is compressed using the existing methods has a lower quality (e.g., pixelated edges, blurring, rings, or the like) and requires more computing power.

Further, artificial intelligence (AI) based video compression method is commonly used for compressing the video content in order to maintain the video quality. The AI-based video compression refers to the use of artificial intelligence algorithms to analyze and optimize the compression of the video content. This process leverages machine learning techniques to efficiently reduce the size of the video file while maintaining or even improving its quality. This type of compression is becoming increasingly popular as it can provide better compression results compared to the existing compression methods.

However, the AI-based video compression method has certain limitations because of the memory and time requirements. Deployment of AI-based compression solutions on embedded systems or electronic devices, such as smartphones is becoming impractical. As a result, developing novel solutions to improve the performance of the electronic device while retaining the potential for use of the AI-based compression solutions in such embedded systems is critical.

Complexity is also one of a crucial factor in video compression codec/video compression methods. The existing AI-based video compression method improves the performance of video compression/visual processing by stacking more residual layers into a model to make it deeper. This can cause gradient issues and may hamper real-time solutions, particularly on the embedded systems, such as the smartphones. Further, in many use cases, the increased amount of data in terms of weight contributes to metadata, thereby requiring more memory.

Thus, it is desired to address the above-mentioned disadvantages or shortcomings of the existing compression systems or at least provide a useful alternative that reduces the complexity of a processing pipeline, for example, for video compression, and provides lightweight on-device inference.

The above information is presented as background information only to assist with an understanding of the disclosure. No determination has been made, and no assertion is made, as to whether any of the above might be applicable as prior art with regard to the disclosure.

### DISCLOSURE

### Technical Solution

This summary is provided to introduce a selection of concepts, in a simplified format, that are further described in the detailed description of the disclosure. This summary is neither intended to identify key or essential inventive concepts of the disclosure nor is it intended for determining the scope of the disclosure.

Aspects of the disclosure are to address at least the above-mentioned problems and/or disadvantages and to provide at least the advantages described below. Accordingly, an aspect of the disclosure is to provide a method and a system for reducing complexity of a processing pipeline using feature-augmented training.

Additional aspects will be set forth in part in the description which follows and, in part, will be apparent from the description, or may be learned by practice of the presented embodiments.

In accordance with an aspect of the disclosure, a method for global view feature augmentation is provided. The method may include receiving an input signal, wherein the input signal is a spatial domain signal, obtaining a spectral domain signal, by converting the received input signal into the spectral domain signal. The method may include extracting a first set of predetermined deep learning features from the corresponding spectral domain signal and a second set of predetermined deep learning features from the spatial domain signal. The method may include converting the extracted first set of spectral domain features in the spatial domain. The method may include and concatenating the second set of spatial domain features and the first set of features converted from spectral to the spatial domain.

In accordance with an aspect of the disclosure, a method for training a neural network using feature augmentation is provided. The method may include receiving an input image signal, wherein the input image signal is the spatial domain signal. The method may include converting, using the neural network, the received input image signal into a corresponding spectral domain signal. The method may include extracting a first set of predetermined learning features from the spectral domain signal and a second set of predetermined learning features from the spatial domain signal. The method may include converting, using the neural network, the first set of predetermined learning features extracted from the spectral domain signal into the spatial domain signal. The method may include concatenating the extracted second set of predetermined learning features and the converted first set of predetermined learning features. The method may include calculating a final loss incurred during the processing of the input image signal using a first loss, a second loss, and a third loss. The method may include and providing, feature-augmented training to the neural network using the calculated final loss.

According to an embodiment of the disclosure, the first loss is computed by performing a first operation, the second loss is computed by performing a second operation, and the third loss is computed by performing a third operation.

According to an embodiment of the disclosure, the first operation includes comparing the converted first set of predetermined learning features and a predefined spectral domain ground truth associated with the input image signal and calculating the first loss based on a result of the comparison.

According to an embodiment of the disclosure, the second operation includes extracting a set of reconstructed features from the extracted second set of predetermined learning features, by rescaling the pixel values such that it is an independent model output, and comparing the reconstructed features with a predefined ground truth associated with the received input image signal to calculate the second loss based on a result of the comparison.

According to an embodiment of the disclosure, the third operation includes blending the set of concatenated learning features, comparing the set of blended learning features and the predefined ground truth associated with the received input image signal, and calculating the third loss based on a result of the comparison.

According to an embodiment of the disclosure, the method includes assigning a first weight, a second weight, and a third weight to the first loss, the second loss, and the third loss, respectively. The method further includes calculating the final loss by combining the first loss, the second loss, and the third loss based on the first weight, the second weight, and the third weight, respectively.

According to an embodiment of the disclosure, the method includes performing at least one of, testing the trained neural network by using only the extracted first set of predetermined learning features or deploying the trained neural network using only the extracted first set of predetermined learning features.

According to an embodiment of the disclosure, the trained neural network is configured to perform video data compression.

In accordance with an aspect of the disclosure, a system for global view feature augmentation is provided. The system may include a memory and at least one processor. The system may include an image processing engine that is operably connected to the memory. The at least one processor is configured to receive the input signal, wherein the input signal is the spatial domain signal. The at least one processor obtain the spectral domain signal, by converting the received input signal into the spectral domain signal. The at least one processor extract the first set of predetermined deep learning features from the corresponding spectral domain signal and the second set of predetermined deep learning features from the spatial domain signal. The at least one processor convert the extracted first set of spectral domain features in the spatial domain. The at least one processor concatenate the second set of spatial domain features and the first set of features converted from spectral to the spatial domain.

In accordance with an aspect of the disclosure, a system for training the neural network using feature augmentation is provided. The system may include a memory and at least one processor. The system may include an image processing engine that is operably connected to the memory. The at least one processor is configured to receive the input image signal, wherein the input image signal is the spatial domain signal. The at least one processor convert the received input image signal into the corresponding spectral domain signal. The at least one processor extract the first set of predetermined learning features from the spectral domain signal and the second set of predetermined learning features from the spatial domain signal. The at least one processor convert the first set of predetermined learning features extracted from the spectral domain signal into the spatial domain signal. The at least one processor concatenate the extracted second set of predetermined learning features and the converted first set of predetermined learning features. The at least one processor calculate the final loss incurred during the processing of the input image signal using the first loss, the second loss, and the third loss. The at least one processor provide feature-augmented training to the neural network using the calculated final loss.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other features, aspects, and advantages of certain embodiments of the disclosure will be more apparent from the following description taken in conjunction with the accompanying drawings, in which:

FIG. 1 illustrates a block diagram of an electronic device for compressing video content using feature-augmented training and low-complexity in-loop filter inference according to an embodiment of the disclosure;

FIG. 2A is a flow diagram illustrating a method for compressing a video content using a feature-augmented training and a low-complexity in-loop filter inference according to an embodiment of the disclosure;

FIG. 2B is a flow diagram illustrating a method for compressing a video content using a feature-augmented training and a low-complexity in-loop filter inference according to an embodiment of the disclosure;

FIG. 3 illustrates a system for a feature-augmented training for compressing a video content according to an embodiment of the disclosure; and

FIG. 4 illustrates a low-complexity in-loop filter inference for compressing a video content according to an embodiment of the disclosure.

The same reference numerals are used to represent the same elements throughout the drawings.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Reference throughout this specification to “an aspect,” “another aspect” or similar language means that a particular feature, structure, or characteristic described in connection with the embodiment is included in at least one embodiment of the disclosure. Thus, appearances of the phrase “in an embodiment,” “in another embodiment,” and similar language throughout this specification may, but do not necessarily, all refer to the same embodiment.

The terms “comprise”, “comprising”, or any other variations thereof, are intended to cover a non-exclusive inclusion, such that a process or method that includes a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. In addition, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits, such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports, such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the disclosure should be construed to extend to any alterations, equivalents, and substitutes in addition to those which are particularly set out in the accompanying drawings. Although the terms first, second, or the like, may be used herein to describe various elements, these elements should not be limited by these terms. These terms are generally only used to distinguish one element from another.

Throughout this disclosure, the terms “first set of predetermined deep learning features” and “first set of predetermined learning features” are used interchangeably and mean the same. The terms “second set of predetermined deep learning features” and “second set of predetermined learning features” are used interchangeably and mean the same.

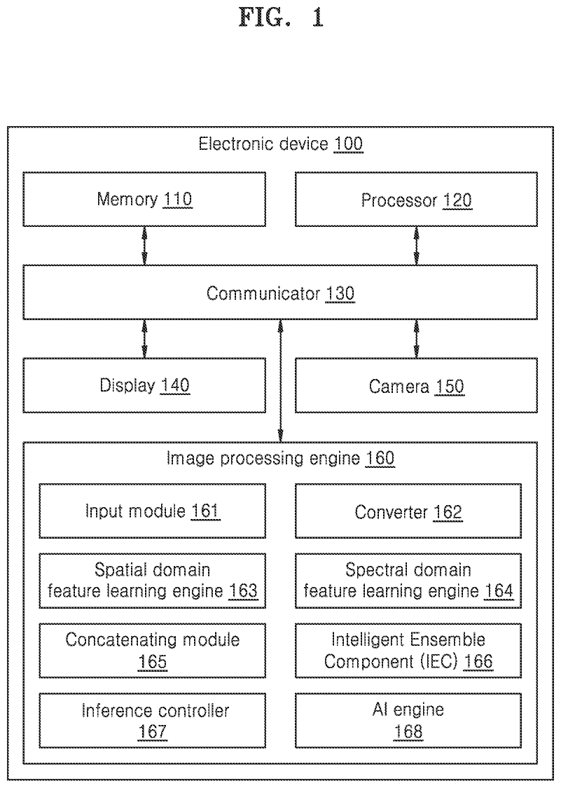

Referring now to the drawings, and more particularly to FIGS. 1, 2A, 2B, 3, and 4, where similar reference characters denote corresponding features consistently throughout the figures, there are shown preferred embodiments.

FIG. 1 illustrates a block diagram of an electronic device (100) for compressing video content using feature-augmented training and low-complexity in-loop filter inference according to an embodiment of the disclosure.

Referring to FIG. 1, examples of the electronic device (100) include, but are not limited to a smartphone, a tablet computer, a personal digital assistance (PDA), an Internet of things (IoT) device, a wearable device, or the like.

In an embodiment of the disclosure, the electronic device (100) includes a memory (110), a processor (120), a communicator (130), a display (140), a camera (150), and an image processing engine (160). According to one embodiment of the disclosure, the electronic device 100 may not include at least one of a communicator 130, a display 140, a camera 150, and an image processing engine 160, and may include other additional components.

In an embodiment of the disclosure, the memory (110) stores a plurality of input image signals, a first set of predetermined deep learning features, a second set of predetermined deep learning features, a first loss, a second loss, a third loss, a final loss, a first weight, a second weight, and a third weight. The memory (110) stores instructions to be executed by the processor (120). The memory (110) may include non-volatile storage elements. Examples of such non-volatile storage elements may include magnetic hard discs, optical discs, floppy discs, flash memories, or forms of electrically programmable read only memories (ROMs) (EPROM) or electrically erasable and programmable ROM (EEPROM) memories. In addition, the memory (110) may, in some examples, be considered a non-transitory storage medium. The term “non-transitory” may indicate that the storage medium is not embodied in a carrier wave or a propagated signal. However, the term “non-transitory” should not be interpreted that the memory (110) is non-movable. In some examples, the memory (110) can be configured to store larger amounts of information than the memory. In certain examples, a non-transitory storage medium may store data that can, over time, change (e.g., in random access memory (RAM) or cache). The memory (110) can be an internal storage unit, or it can be an external storage unit of the electronic device (100), a cloud storage, or any other type of external storage.

The processor (120) is configured to communicate with the memory (110), the communicator (130), the display (140), the camera (150), and the image processing engine (160). The processor (120) is configured to execute instructions stored in the memory (110) and to perform various processes. The processor (120) may include one or a plurality of processors, maybe a general-purpose processor, such as a central processing unit (CPU), an application processor (AP), or the like, a graphics-only processing unit, such as a graphics processing unit (GPU), a visual processing unit (VPU), and/or an Artificial intelligence (AI) dedicated processor, such as a neural processing unit (NPU). The processor (120) includes processing circuitry, such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports, such as printed circuit boards and the like.

The communicator (130) is configured for communicating internally between internal hardware components and with external devices (e.g., server) via one or more networks (e.g., Radio technology). The communicator (130) includes an electronic circuit specific to a standard that enables wired or wireless communication. The display (140) can accept user inputs and is made of a liquid crystal display (LCD), a light emitting diode (LED), an organic light emitting diode (OLED), or another type of display. The User inputs may include but are not limited to, touch, swipe, drag, gesture, voice command, and so on. The camera (150) includes one or more image sensors (e.g., charged coupled device (CCD), complementary metal-oxide semiconductor (CMOS)) to capture one or more images/image frames.

The image processing engine (160) is configured to operably connect with the memory (110) and the processor (120) to perform various operations for compressing the video content using the feature-augmented training and the low-complexity in-loop filter inference. Referring to FIG. 1, an image processing engine 160 is shown as an independent component according to an embodiment of the disclosure, but is not limited thereto. According to an embodiment of the disclosure, the image processing engine 160 may be composed of modules stored in the memory 110. The processor 120 may perform an operation of a method described later by executing the image processing engine 160 stored in the memory 110.

In an embodiment of the disclosure, the image processing engine (160) includes an input module (161), a converter (162), a spatial domain feature learning engine (163), a spectral domain feature learning engine (164), a concatenating module (165), an intelligent ensemble component (IEC) (166), an inference controller (167), and an artificial intelligence (AI) engine (168).

The input module (161) receives an input image signal, where the input image signal(s) is a spatial domain signal. The input module (161) sends the received input image signal to the converter (162) for further processing. The input image signal is represented by a first set of dimensions with a specific height and width with respect to the input image pixels and one or more first channels (e.g., HXWXC1). Where H denotes tensor height, W denotes tensor width, and C denotes the number of channels in a tensor.

The converter (162) converts the received input image signal into a corresponding spectral domain signal using a neural network/AI engine (168). The converted spectral domain signal is represented by a second set of dimensions that has the specific height and weight with respect to the image pixels of the input image signals and one or more second channels (e.g., HXWXC2).

The spatial domain feature learning engine (163) extracts the second set of predetermined learning features (e.g., content-specific deep learning feature map which are feature maps that lead to desired transformations based on a type of input, such as smooth content vs. textured content) from the spatial domain signal by utilizing the AI engine (168) (e.g., residual neural network (resnet)) and sends the extracted second set of predetermined learning features to the concatenating module (165) for further processing. Furthermore, the spatial domain feature learning engine (163) extracts a set of reconstructed features from the extracted second set of predetermined learning features. The spectral domain feature learning engine (164) extracts the first set of predetermined learning features (e.g., content-specific deep learning feature map) from the spectral domain signal by using the AI engine (168) (e.g., resnet).

The converter (162) then converts the first set of predetermined learning features extracted from the spectral domain signal into the spatial domain signal. The concatenating module (165) concatenates the extracted second set of predetermined learning features and the converted first set of predetermined learning features. The concatenation process maybe but not limited to simple methods as arranging along multiple channels using classical methods or as complex as using deep learning blocks (e.g., AI engine (168)). Where the concatenated signal is represented by a third set of dimensions that has the specific height and weight with respect to the image pixels of the input image signals and one or more third channels (e.g., HXWXC3). Furthermore, the concatenating module (165) sends the concatenated learning features to the IEC (166) for further processing.

The IEC (166) performs a blending operation upon receiving the concatenated learning features from the concatenating module (165) and generates blended learning features/blended signals by blending the concatenated learning features. The blending process maybe but not limited to simple methods as blending using classical methods at pixel level or as complex as using deep learning blocks for blending. The blended signal is represented by the third set of dimensions that has the specific height and weight with respect to the image pixels of the input image signals and one or more third channels (e.g., HXWXC4).

Furthermore, the IEC (166) calculates the final loss incurred during the processing of the input image signal using the first loss, the second loss, and the third loss. The first loss is computed by performing the first operation, the second loss is computed by performing the second operation, and the third loss is computed by performing the third operation.

The first operation includes comparing the converted first set of predetermined learning features and a predefined spectral domain ground truth associated with the input image signal and calculating the first loss based on a result of the comparison. The predefined spectral domain ground truth is a first reference signal for comparison.

The second operation includes extracting the set of reconstructed features from the extracted second set of predetermined learning features, by rescaling the pixel values such that it is an independent model output which is used in the inference stage, comparing the extracted set of reconstructed features and a predefined ground truth associated with the received input image signal, and calculating the second loss based on a result of the comparison. The predefined ground truth is a second reference signal for comparison.

The third operation includes blending the set of concatenated learning features, comparing the set of blended learning features and a predefined ground truth associated with the received input image signal, and calculating the third loss based on a result of the comparison.

Furthermore, the IEC (166) assigns the first weight, the second weight, and the third weight to the first loss, the second loss, and the third loss, respectively. The IEC (166) then calculates the final loss by combining the first loss, the second loss, and the third loss based on the first weight, the second weight, and the third weight, respectively.

The inference controller (167) performs backpropagation during model training such that the learnings from the spectral domain feature learning engine (164) and from IEC affects the performance of the spatial domain feature learning engine (163) as well. This enables the spatial domain feature learning engine (163) to learn beyond its capabilities. The inference controller (167) performs testing the trained neural network by using only the extracted first set of predetermined learning features (referred to, but not limited to, as detaching the spectral stream and ensemble components) and/or deploying the trained neural network by using only the extracted first set of predetermined learning features.

In one embodiment of the disclosure, the inference controller (167) performs model training using the final loss obtained from the IEC (166) and low complexity in-loop filter inference by detaching the system's spectral stream and ensemble components, thereby significantly reducing solution complexity at the time of inference (also reduces memory footprint because the system doesn't have to consider feature weights of the spectral stream and the ensemble component). The inference controller (167) then deploys the trained model (e.g., deep neural network/AI engine (168)) by using only the first set of predetermined learning features that are extracted from the corresponding first spatial domain signals.

A function associated with the various hardware components of the electronic device (100) may be performed through the non-volatile memory, the volatile memory, and the processor (120). One or a plurality of processors controls the processing of the input data in accordance with a predefined operating rule or AI model (i.e., AI engine (168)) stored in the non-volatile memory and the volatile memory. The predefined operating rule or AI model is provided through training or learning. Here, being provided through learning means that, by applying a learning algorithm to a plurality of learning data, a predefined operating rule or AI model of the desired characteristic is made. The learning may be performed in a device itself in which AI according to an embodiment is performed, and/or may be implemented through a separate server/system. The learning algorithm is a method for training a predetermined target device (for example, a robot) using a plurality of learning data to cause, allow, or control the target device to decide or predict. Examples of learning algorithms include, but are not limited to, supervised learning, unsupervised learning, semi-supervised learning, or reinforcement learning.

The AI model may consist of a plurality of neural network layers. Each layer has a plurality of weight values and performs a layer operation through a calculation of a previous layer and an operation of a plurality of weights. Examples of neural networks include, but are not limited to, convolutional neural network (CNN), deep neural network (DNN), recurrent neural network (RNN), restricted Boltzmann machine (RBM), deep belief network (DBN), bidirectional recurrent deep neural network (BRDNN), generative adversarial networks (GAN), and deep Q-networks.

Although FIG. 1 shows an example hardware components of the electronic device (100) according to an embodiment, however, not limited thereon. According to an embodiment of the disclosure, the electronic device (100) may include less or more number of components. Further, the labels or names of the components are used only for illustrative purpose and does not limit the scope of the disclosure. One or more components can be combined to perform the same or substantially similar functions to compress the video content using the feature-augmented training and the low-complexity in-loop filter inference.

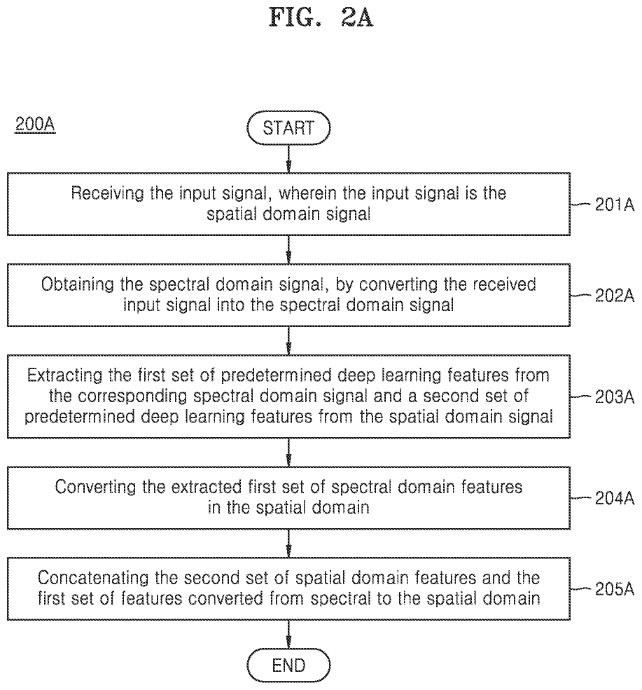

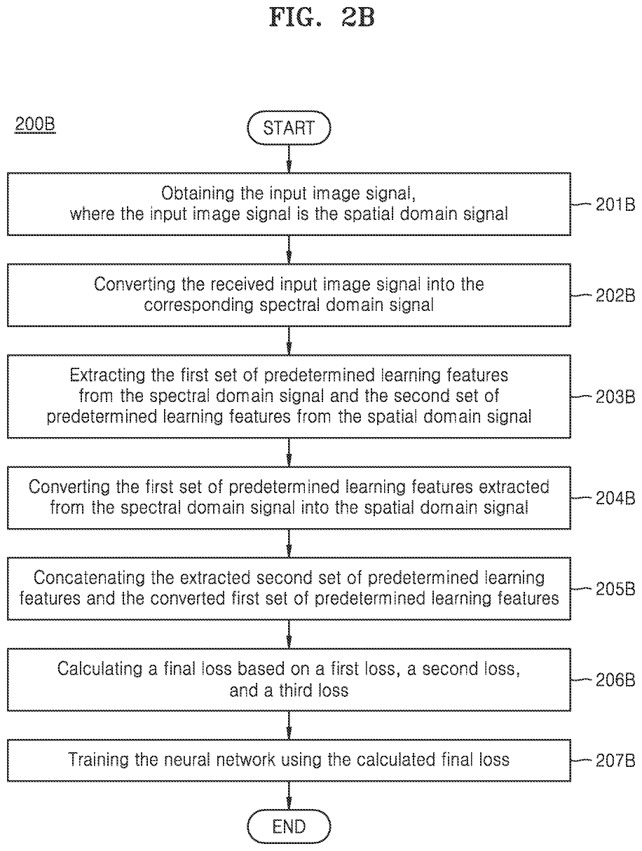

FIG. 2A is a flow diagram illustrating a method (200A) for compressing a video content using a feature-augmented training and a low-complexity in-loop filter inference according to an embodiment of the disclosure.

Referring to FIG. 2A, operations 201A to 205A are performed by the electronic device (100) to compress the video content using the feature-augmented training and the low-complexity in-loop filter inference.

At operation 201A, the method (200A) includes receiving the input signal, wherein the input signal is the spatial domain signal. At operation 202A, the method (200A) includes obtaining the spectral domain signal, by converting the received input signal into the spectral domain signal. At operation 203A, the method (200A) includes extracting the first set of predetermined deep learning features from the corresponding spectral domain signal and the second set of predetermined deep learning features from the spatial domain signal. At operation 204A, the method (200A) includes converting the extracted first set of spectral domain features in the spatial domain. At operation 205A, the method (200A) includes concatenating the second set of spatial domain features and the first set of features converted from spectral to the spatial domain.

FIG. 2B is a flow diagram illustrating a method (200B) for compressing a video content using a feature-augmented training and a low-complexity in-loop filter inference according to an embodiment of the disclosure.

Referring to FIG. 2B, operations 201B to 207B are performed by the electronic device (100) to compress the video content using the feature-augmented training and the low-complexity in-loop filter inference.

At operation 201B, the method (200B) includes receiving the input image signal, where the input image signal is the spatial domain signal, which relates to operation 201A of FIG. 2A. For example, the input module (161) receives an input image signal, where the input image signal(s) is the spatial domain signal. At operation 202B, the method (200B) includes converting the received input image signal into the corresponding spectral domain signal, which relates to operation 202A of FIG. 2A. For example, the converter (162) converts the received input image signal into the corresponding spectral domain signal using the neural network/AI engine (168). At operation 203B, the method (200B) includes extracting the first set of predetermined learning features from the spectral domain signal and the second set of predetermined learning features from the spatial domain signal, which relates to operation 203A of FIG. 2A. For example, the spatial domain feature learning engine (163) extracts the second set of predetermined learning features from the spatial domain signal by utilizing the AI engine (168) and the spectral domain feature learning engine (164) extracts the first set of predetermined learning features from the spectral domain signal by using the AI engine (168). At operation 204B, the method (200B) includes converting the first set of predetermined learning features extracted from the spectral domain signal into the spatial domain signal. For example, the converter (162) then converts the first set of predetermined learning features extracted from the spectral domain signal into the spatial domain signal, which relates to operation 204A of FIG. 2A.

At operation 205B, the method (200B) includes concatenating the extracted second set of predetermined learning features and the converted first set of predetermined learning features. For example, the concatenating module (165) concatenates the extracted second set of predetermined learning features and the converted first set of predetermined learning features, which relates to operation 205A of FIG. 2A. At operation 206B, the method (200B) includes calculating the final loss incurred during the processing of the input image signal using the first loss, the second loss, and the third loss, which relates to operation 205A of FIG. 2A. For example, the IEC (166) calculates the final loss incurred during the processing of the input image signal using the first loss, the second loss, and the third loss. At operation 207B, the method (200B) includes providing the feature-augmented training to the neural network using the calculated final loss, which relates to operation 205A of FIG. 2A. For example, the inference controller (167) performs testing the trained neural network by using only the extracted first set of predetermined learning features and/or deploying the trained neural network by using only the extracted first set of predetermined learning features.

The various actions, acts, blocks, operations, or the like in the flow diagrams may be performed in the order presented, in a different order, or simultaneously. According to an embodiment of the disclosure, some of the actions, acts, blocks, operations, or the like may be omitted, added, modified, skipped, or the like without departing from the scope of the disclosure.

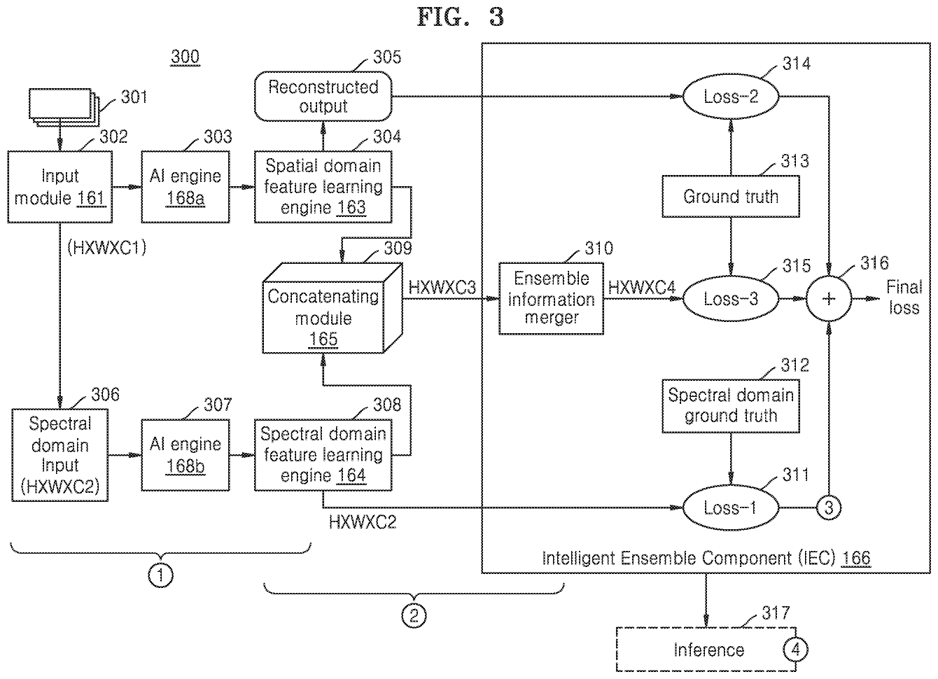

The disclosed method (200A and 200B) includes various stages for compressing the video content using the feature-augmented training and the low-complexity in-loop filter inference as shown in FIG. 3. Stage-1 is for feature extraction and augmentation using multi-stream (e.g., spatial stream, spectral stream, or the like) and multi-domain network (e.g., spatial domain, spectral domain, or the like) leading to simultaneous local input view and global input view. The local input view includes, but not limited to, local convolutions over the input image signal. The global input view includes, but not limited to, transforms leading to each pixel embedding information about entire image and hence, convolution over such transformed input gives information about the entire image. Stage-2 is for blending and merging the original features (e.g., the first set of predetermined learning features, the second set of predetermined learning features, or the like) and the augmented features (e.g., concatenated learning features). Stage-3 is for a multi-loss approach in which various stages contribute to different losses (e.g., loss-1, loss-2, loss-3, or the like), resulting in feature-augmented training. Stage-4 is for reducing complexity by detaching parts of the overall pipeline (greyed-out parts) during inference.

FIG. 3 illustrates a system (300) for a feature-augmented training for compressing a video content according to an embodiment of the disclosure.

Referring to FIG. 3, operations 301 to 317 are performed by the electronic device (100) to compress the video content using the feature-augmented training and the low-complexity in-loop filter inference.

At operations 301 to 302, the system (300) includes receiving, by the input module (161), the input image signal (e.g., image frames (301)), where the input image signal is the spatial domain signal. The input image signal is represented by the first set of dimensions with the specific height and width with respect to the input image pixels and one or more first channels (e.g., HXWXC1). The converter (162) (not shown in FIG. 3) then converts the received input image signal into the corresponding spectral domain signal. Furthermore, the converter (162) sends the received input image signal to the spatial domain feature learning engine (163) for further processing.

At operations 303 to 304, the system (300) includes extracting, by the spatial domain feature learning engine (163), the second set of predetermined learning features from the spatial domain signal by using the AI engine (168). The spatial domain feature learning engine (163) then sends the extracted second set of predetermined learning features to the concatenating module (165) for further processing. At operation 305, the system (300) includes extracts, by the spatial domain feature learning engine (163), the set of reconstructed features from the extracted second set of predetermined learning features.

At operation 306, the system (300) includes converting, by the converter (162), the received input image signal into the corresponding spectral domain signal. The converted spectral domain signal is represented by the second set of dimensions that has the specific height and weight with respect to the image pixels of the input image signals and one or more second channels (e.g., HXWXC2). The converter (162) then sends the converted spectral domain signal to the spectral domain feature learning engine (164) for further processing. At operations 307 to 308, the system (300) includes extracting, by the spectral domain feature learning engine (164), the first set of predetermined learning features from the spectral domain signal by using the AI engine (168). Furthermore, the converter (162) then converts the first set of predetermined learning features extracted from the spectral domain signal into the spatial domain signal, then the extracted spectral domain signal is sent to the concatenating module (165) for further processing.

At operation 309, the system (300) includes concatenating, by the concatenating module (165), the extracted second set of predetermined learning features and the converted first set of predetermined learning features. The concatenating module (165) then generates the concatenated signals (concatenated learning features) is represented by the third set of dimensions that has the specific height and weight with respect to the image pixels of the input image signals and one or more third channels (e.g., HXWXC3). Furthermore, the concatenating module (165) sends the concatenated learning features to the IEC (166) for further processing. At operation 310, the method includes performing, by an ensemble information merger of the IEC (166), the blending operation upon receiving the concatenated learning features from the concatenating module (165) and generating, by the ensemble information merger, blended learning features (e.g., HXWXC4) by blending the concatenated learning features.

At operations 311 to 312, the system (300) includes determining, by the IEC (166), the first loss (i.e., Loss-1). The first loss is computed by performing the first operation. The first operation includes comparing the converted first set of predetermined learning features and the predefined spectral domain ground truth associated with the input image signal and calculating the first loss based on the result of the comparison. At operations 313 to 314, the system (300) includes determining, by the IEC (166), the second loss (i.e., Loss-2). The second loss is computed by performing the second operation. The second operation includes comparing the extracted set of reconstructed features and the predefined ground truth associated with the received input image signal and calculating the second loss based on the result of the comparison. At operation 315, the system (300) includes determining, by the IEC (166), the third loss (i.e., Loss-3). The third loss is computed by performing the third operation. The third operation includes blending the set of concatenated learning features, comparing the set of blended learning features and the predefined ground truth associated with the received input image signal, and calculating the third loss based on the result of the comparison.

At operation 316, the system (300) includes determining, by the IEC (166), the final loss incurred during the processing of the input image signal using the first loss, the second loss, and the third loss. In one embodiment of the disclosure, the final loss is determined by performing the plurality of computational operations (e.g., summation, assigning specific weight, or the like). In an embodiment of the disclosure, the IEC (166) assigns the first weight, the second weight, and the third weight to the first loss, the second loss, and the third loss, respectively. The IEC (166) determines the final loss by combining the first loss, the second loss, and the third loss based on the first weight, the second weight, and the third weight, respectively. At operation 317, the system (300) includes stores, by the IEC (166), the determined final loss for backpropagation that may be used in the inference stage. All the losses have been designed in such a way that they enable detachable stream functionality and backpropagation based on both streams.

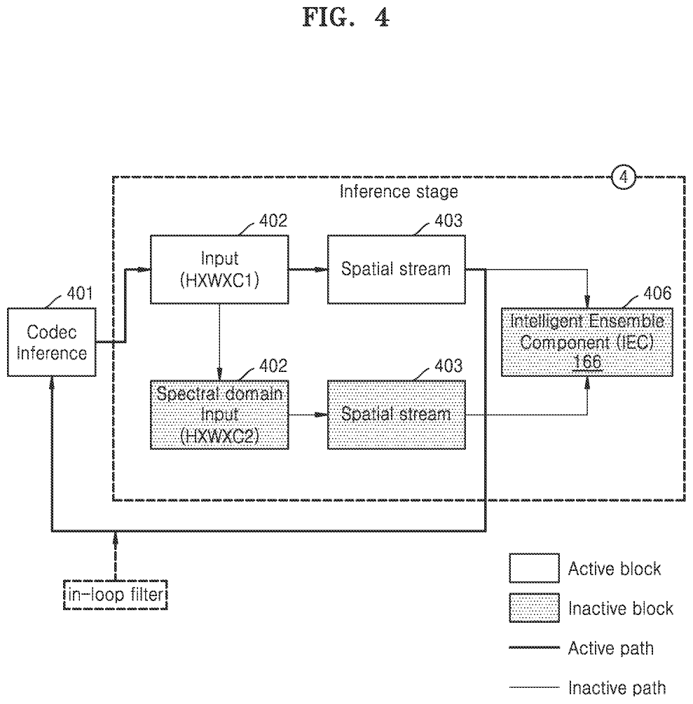

FIG. 4 illustrates a low-complexity in-loop filter inference for compressing a video content according to an embodiment of the disclosure.

Referring to FIG. 4, consider a scenario where the electronic device (100) detects initiation of inference stage/mode upon receiving codec data (e.g., compresses or decompresses media files, such as songs or videos) from a codec interference (401) of the electronic device (100). The codec inference (401) passes the codec data to the inference controller (167). The inference controller (167) then disconnects the spectral stream (404 and 405), represented by an inactive clock/inactive path, and ensemble components (406) while keeping only the spatial stream (402 and 403), represented by an active block/active path. The inference controller (167) improves the quality of the codec data based on the calculated final loss by using only the spatial stream (402 and 403), also known as an in-loop filter. As a result, the disclosed method/system reduces complexity during the inference stage/mode (and also reduces memory footprint because the system no longer needs to consider feature weights of the spectral stream and the ensemble component).

Unlike existing methods and systems, the disclosed method (200A and 200B) and/or the system (300) provide the feature-augmented training to the neural network (NN) (e.g., AI engine (168)) based on the determined final loss. The final loss is determined by processing the plurality of input image signals by performing the plurality of computational operations based on the first set of predetermined learning features, the second set of predetermined learning features, and the blending operation of the concatenated learning features. Furthermore, the disclosed method (200A and 200B) and/or the system (300) include novel features, such as an amalgamation module (i.e., ensemble information merger) and detachable model (i.e., interference controller (167)) for improving video codec output using the disclosed/novel technique for in-loop filter inference using the NN with complexity reduction via the feature-augmented training, resulting in a good performance on embedded systems, such as smartphones. The feature-augmented training enabled by combining multiple losses in a novel way is useful for reducing model complexity during inference and thus helps to avoid making the NN model deeper in order to realize a better performance. As a result, the disclosed method (200A and 200B) and/or the system (300) extract feature much faster and achieve better image quality enhancement at a lower complexity during in-loop filter inference without using a deeper architecture of the NN model, which is otherwise required for convolution to have a larger receptive field. Furthermore, encoding the above selection method in the bit stream will assist a decoder in employing the same method as an encoder.

Unlike existing methods and systems, the disclosed method (200A and 200B) provided several technical advantages. The disclosed system (300) and/or the electronic device (100), for example, are capable of extracting features much faster and achieving better image quality enhancement at a reduced complexity of the processing pipeline for the video compression, without employing a deeper architecture of the NN, which is otherwise required for convolution to have a larger receptive field. The disclosed system (300) and/or the electronic device (100) are capable of reducing processing time as well as memory requirements while producing better results, resulting in a good performance on the embedded system or electronic device (100). The disclosed system (300) and/or the electronic device (100) are capable of producing better results not only in terms of metrics but also in terms of subjective quality.

According to an embodiment of the disclosure, a method for training a neural network using feature augmentation is provided. The method may include obtaining an input image signal. The input image signal may be a spatial domain signal. The method may include converting the received input image signal into a corresponding spectral domain signal. The method may include extracting a first set of predetermined learning features from the spectral domain signal and a second set of predetermined learning features from the spatial domain signal. The method may include converting the first set of predetermined learning features extracted from the spectral domain signal into the spatial domain signal. The method may include concatenating the extracted second set of predetermined learning features and the converted first set of predetermined learning features. The method may include calculating a final loss based on a first loss, a second loss, and a third loss. The method may include training the neural network using the calculated final loss.

According to an embodiment of the disclosure, the method may include calculating the first loss based on the converted first set of predetermined learning features and a predefined spectral domain ground truth associated with the input image signal.

According to an embodiment of the disclosure, the method may include extracting a set of reconstructed features from the extracted second set of predetermined learning features. The method may include calculating the second loss based on the extracted set of reconstructed features and a predefined ground truth associated with the received input image signal.

According to an embodiment of the disclosure, the method may include blending the set of concatenated learning features. The method may include calculating the third loss based on the set of blended learning features and a predefined ground truth associated with the received input image signal.

According to an embodiment of the disclosure, the final loss may be determined based on weighted sum of the first weight, the second weight, and the third weight.

According to an embodiment of the disclosure, the method may include performing at least one of: testing the trained neural network by using only the extracted first set of predetermined learning features, or deploying the trained neural network by using only the extracted first set of predetermined learning features.

According to an embodiment of the disclosure, the trained neural network is configured to perform video data compression.

According to an embodiment of the disclosure, a computer-readable recording medium having recorded thereon a program that is executable by a process to perform the method of any one of forgoing method is provided.

According to an embodiment of the disclosure, an electronic device for training a neural network using feature augmentation is provided. The electronic device may include a memory and at least one processor. The at least one processor may be configured to obtain an input image signal, wherein the input image signal is a spatial domain signal. The at least one processor may be configured to convert the received input image signal into a corresponding spectral domain signal. The at least one processor may be configured to extract a first set of predetermined learning features from the spectral domain signal and a second set of predetermined learning features from the spatial domain signal. The at least one processor may be configured to convert the first set of predetermined learning features extracted from the spectral domain signal into the spatial domain signal. The at least one processor may be configured to concatenate the extracted second set of predetermined learning features and the converted first set of predetermined learning features. The at least one processor may be configured to calculate a final loss based on a first loss, a second loss, and a third loss. The at least one processor may be configured to train the neural network using the calculated final loss.

According to an embodiment of the disclosure, the at least one processor may be configured to calculate the first loss based on the converted first set of predetermined learning features and a predefined spectral domain ground truth associated with the input image signal.

According to an embodiment of the disclosure, the at least one processor may be configured to extract a set of reconstructed features from the extracted second set of predetermined learning features. The at least one processor may be configured to calculate the second loss based on the extracted set of reconstructed features and a predefined ground truth associated with the received input image signal.

According to an embodiment of the disclosure, the at least one processor may be configured to blend the set of concatenated learning features. The at least one processor may be configured to calculate the third loss based on the set of blended learning features and a predefined ground truth associated with the received input image signal.

According to an embodiment of the disclosure, the final loss is determined based on weighted sum of the first weight, the second weight, and the third weight.

According to an embodiment of the disclosure, the at least one processor may be configured to perform at least one of: test the trained neural network by using only the extracted first set of predetermined learning features, or deploy the trained neural network by using only the extracted first set of predetermined learning features.

According to an embodiment of the disclosure, the trained neural network is configured to perform video data compression.

Unless otherwise defined, all technical and scientific terms used herein have the same meaning as commonly understood by one ordinary skilled in the art to which this disclosure belongs. The system, methods, and examples provided herein are illustrative only and not intended to be limiting.

While specific language has been used to describe the subject matter, any limitations arising on account thereto, are not intended. As would be apparent to a person in the art, various working modifications may be made to the method to implement the inventive concept as taught herein. The drawings and the forgoing description give examples of one or more embodiments. Those skilled in the art will appreciate that one or more of the described elements may well be combined into a single functional element. Alternatively, certain elements may be split into multiple functional elements. Elements from one embodiment may be added to another embodiment.

The one or more embodiments disclosed herein can be implemented using at least one hardware device and performing network management functions to control the elements.

The foregoing description of the specific one or more embodiments will so fully reveal the general nature of the one or more embodiments herein that others can, by applying current knowledge, readily modify and/or adapt for various applications such specific one or more embodiments without departing from the generic concept, and, therefore, such adaptations and modifications should and are intended to be comprehended within the meaning and range of equivalents of the disclosed one or more embodiments. It is to be understood that the phraseology or terminology employed herein is for the purpose of description and not of limitation.

While the disclosure has been shown and described with reference to one or more embodiments thereof, it will be understood by those skilled in the art that various changes in form and details may be made therein without departing from the spirit and scope of the disclosure as defined by the appended claims and their equivalents.

What is claimed is:

1. A method performed by an electronic device for training a neural network using feature augmentation, the method comprising:
obtaining an input image signal, wherein the input image signal is a spatial domain signal;
converting the received input image signal into a corresponding spectral domain signal;
extracting a first set of predetermined learning features from the spectral domain signal and a second set of predetermined learning features from the spatial domain signal;
converting the first set of predetermined learning features extracted from the spectral domain signal into the spatial domain signal;
concatenating the extracted second set of predetermined learning features and the converted first set of predetermined learning features;
calculating a final loss based on a first loss, a second loss, and a third loss; and
training the neural network using the calculated final loss.

2. The method of claim 1, further comprising:
calculating the first loss based on the converted first set of predetermined learning features and a predefined spectral domain ground truth associated with the input image signal.

3. The method of claim 1, further comprising:
extracting a set of reconstructed features from the extracted second set of predetermined learning features; and
calculating the second loss based on the extracted set of reconstructed features and a predefined ground truth associated with the received input image signal.

4. The method of claim 1, further comprising:
blending the set of concatenated learning features; and
calculating the third loss based on the set of blended learning features and a predefined ground truth associated with the received input image signal.

5. The method of claim 1,
wherein the final loss is determined based on weighted sum of the first weight, the second weight, and the third weight.

6. The method of claim 1, further comprising:
performing at least one of:
testing the trained neural network by using only the extracted first set of predetermined learning features, or
deploying the trained neural network by using only the extracted first set of predetermined learning features.

7. The method of claim 1,
wherein the trained neural network is configured to perform video data compression.

8. An electronic device for training a neural network using feature augmentation, the electronic device comprising:
a memory and at least one processor, the at least one processor configured to:
obtain an input image signal, wherein the input image signal is a spatial domain signal,
convert the received input image signal into a corresponding spectral domain signal,
extract a first set of predetermined learning features from the spectral domain signal and a second set of predetermined learning features from the spatial domain signal,
convert the first set of predetermined learning features extracted from the spectral domain signal into the spatial domain signal,
concatenate the extracted second set of predetermined learning features and the converted first set of predetermined learning features,
calculate a final loss based on a first loss, a second loss, and a third loss, and
train the neural network using the calculated final loss.

9. The electronic device of claim 8, wherein the at least one processor configured to:
calculate the first loss based on the converted first set of predetermined learning features and a predefined spectral domain ground truth associated with the input image signal.

10. The electronic device of claim 8, wherein the at least one processor configured to:
extract a set of reconstructed features from the extracted second set of predetermined learning features,
calculate the second loss based on the extracted set of reconstructed features and a predefined ground truth associated with the received input image signal.

11. The electronic device of claim 8, wherein the at least one processor configured to:
blend the set of concatenated learning features, and
calculate the third loss based on the set of blended learning features and a predefined ground truth associated with the received input image signal.

12. The electronic device of claim 8, wherein the final loss is determined based on weighted sum of the first weight, the second weight, and the third weight.

13. The electronic device of claim 8, wherein the trained neural network is configured to perform video data compression.

14. The electronic device of claim 8, wherein the at least one processor configured to perform at least one of:
test the trained neural network by using only the extracted first set of predetermined learning features, or
deploy the trained neural network by using only the extracted first set of predetermined learning features.

15. A non-transitory computer-readable recording medium having recorded thereon a program that is executable by a process to perform the method of claim 1.
